(19) United States
(12) Patent Application Publication
(10) Pub. No.: US 2025/0155651 A1
(43) Pub. Date: May 15, 2025

(54) MULTICORE OPTICAL FERRULE, OPTICAL CONNECTOR, AND MANUFACTURING METHOD OF MULTICORE OPTICAL FERRULE

(71) Applicant: Fujikura Ltd., Tokyo (JP)

(72) Inventor: Yusuke Sakurai, Sakura-shi (JP)

(73) Assignee: Fujikura Ltd., Tokyo (JP)

(21) Appl. No.: 18/940,752

(22) Filed: Nov. 7, 2024

(30) Foreign Application Priority Data
Nov. 10, 2023 (JP) 2023-192428

(51) Int. Cl. G02B 6/38

(52) U.S. Cl. CPC G02B 6/3865; G02B 6/3861

(57) ABSTRACT

A multicore optical ferrule includes a main body including a connection end surface configured to connect to a connection target and insertion holes into which optical fibers are respectively inserted. Each of the insertion holes extends from the connection end surface toward an inside of the main body. Each of the insertion holes has a first inner diameter portion open to the connection end surface and a second inner diameter portion having a diameter larger than a diameter of the first inner diameter portion. An inner wall of the first inner diameter portion of each of the insertion holes includes micro holes.

### CROSS-REFERENCE TO RELATED APPLICATIONS

The present application claims priority to Japanese Patent Application No. 2023-192428, filed on Nov. 10, 2023. The contents of this application are incorporated herein by reference in their entirety.

### BACKGROUND

### Technical Field

The present invention relates to a multicore optical ferrule, an optical connector, and a manufacturing method of a multicore optical ferrule.

### Description of the Related Art

United States Patent Application, Publication No. 2022/0381998 (hereinafter, referred to as Patent Document 1) discloses a ferrule having an insertion hole through which an optical fiber is inserted in a longitudinal direction of the optical fiber. In Patent Document 1, a main chamber that holds a coating of the optical fiber is formed in the ferrule. By providing a plurality of recessed portions on an inner wall of the main chamber, an amount of an adhesive with which the main chamber is filled can be increased, and the coating of the optical fiber can firmly adhere to the main chamber.

In a structure of Patent Document 1, the coating of the optical fiber can firmly adhere to the ferrule, but in the optical fiber, the coating and a bare fiber disposed inside the coating relatively move. In order to reduce a splice loss in a connection between an optical connector and a connection target, it is required to stabilize the position of the bare fiber of the optical fiber exposed on a connection end surface of the ferrule that is connected to the connection target. Therefore, it is desired that the bare fiber of the optical fiber firmly adheres to the ferrule in the vicinity of the connection end surface.

### SUMMARY

One or more embodiments provide a multicore optical ferrule, an optical connector, and a manufacturing method of a multicore optical ferrule capable of improving adhesive strength of a bare fiber of an optical fiber with respect to the multicore optical ferrule in the vicinity of a connection end surface.

A multicore optical ferrule according to one or more embodiments includes a main body including a connection end surface to be connected to a connection target, and a plurality of insertion holes which extend from the connection end surface toward an inside of the main body and through which an optical fiber is insertable, in which each of the plurality of insertion holes includes a first inner diameter portion that is open to the connection end surface and a second inner diameter portion that has a larger diameter than a diameter of the first inner diameter portion, and an inner wall of the first inner diameter portion includes a plurality of micro holes.

In addition, the multicore optical ferrule may further include a reception portion that communicates with the second inner diameter portion and is configured to receive a coating of the optical fiber.

In addition, in the multicore optical ferrule, the second inner diameter portion may include the plurality of micro holes.

In addition, in the multicore optical ferrule, widths of openings of at least some micro holes among the plurality of micro holes may be 1 μm or greater.

An optical connector according to one or more embodiments includes the multicore optical ferrule, a plurality of optical fibers inserted through the plurality of insertion holes, and an adhesive configured to cause the plurality of optical fibers to adhere to the multicore optical ferrule, in which the adhesive is disposed at least between a bare fiber of the optical fiber and the first inner diameter portion.

A manufacturing method of a multicore optical ferrule according to one or more embodiments is a manufacturing method of a multicore optical ferrule that includes a main body including a connection end surface and a plurality of insertion holes extending from the connection end surface toward an inside of the main body, the method including preparing a mold main body configured to form an outer surface of the main body and an insertion hole pin configured to form the insertion hole, attaching fine particles to the insertion hole pin, installing the insertion hole pin to which the fine particles have been attached in the mold main body, injecting a resin into the mold main body and solidifying the resin, and removing the fine particles remaining in the solidified resin.

According to one or more embodiments, it is possible to provide a multicore optical ferrule, an optical connector, and a manufacturing method of a multicore optical ferrule capable of improving adhesive strength of a bare fiber of an optical fiber with respect to the multicore optical ferrule in the vicinity of a connection end surface.

### BRIEF DESCRIPTION OF THE DRAWINGS

FIG. 1 is a perspective view of an optical connector according to one or more embodiments.

FIG. 2 is a cross-sectional view taken along a line II-II of FIG. 1.

FIG. 3 is a perspective view of FIG. 2.

FIG. 4 is a flowchart showing an example of a manufacturing method of a multicore optical ferrule according to one or more embodiments.

FIG. 5 is a diagram for describing a step of attaching fine particles to an insertion hole pin in the manufacturing method of a multicore optical ferrule according to one or more embodiments.

FIG. 6 is a diagram for describing an injection molding step in the manufacturing method of a multicore optical ferrule according to one or more embodiments.

### DESCRIPTION OF THE EMBODIMENTS

Hereinafter, a multicore optical ferrule and an optical connector according to one or more embodiments will be described with reference to the accompanying drawings.

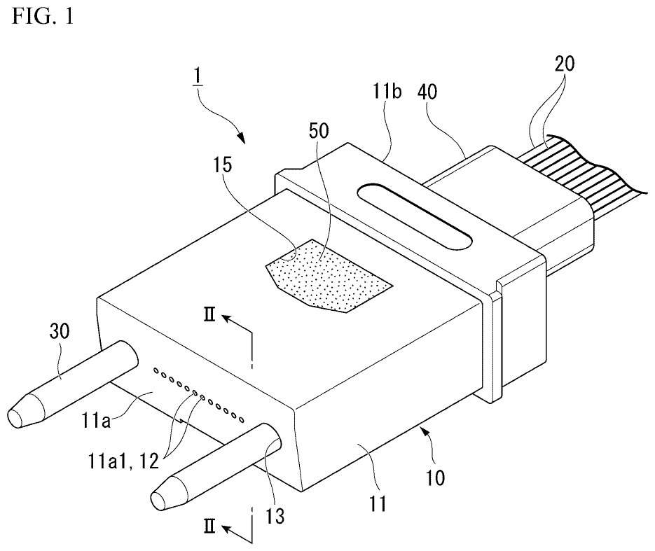

As shown in FIG. 1, an optical connector 1 includes a multicore optical ferrule 10, a plurality of optical fibers 20, two guide pins 30, a boot 40, and an adhesive 50. The optical connector 1 need not include the guide pins 30 and the boot 40.

The multicore optical ferrule 10 includes a ferrule main body 11 (main body). A plurality of insertion holes 12 through which the plurality of optical fibers 20 are individually insertable are formed in the ferrule main body 11. The ferrule main body 11 includes a connection end surface 11a to which the insertion holes 12 are open.

### (Definition of Direction)

In the present specification, a longitudinal direction of the insertion hole 12 is referred to as an axial direction. In addition, a side of the connection end surface 11a in the axial direction is referred to as a front side or a distal end side, and an opposite side thereof is referred to as a rear side or a base end side.

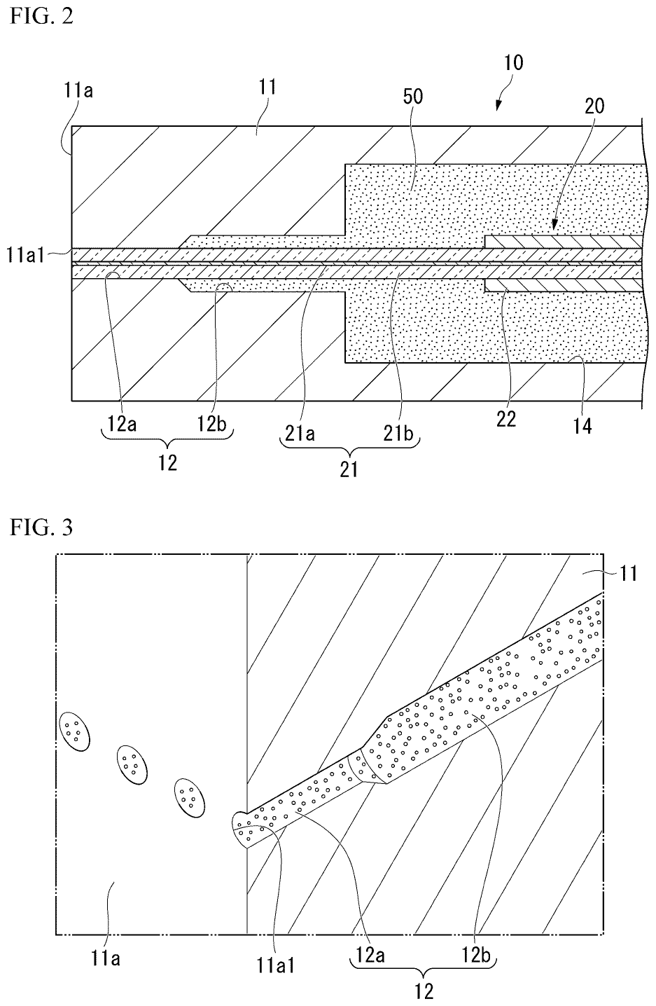

The multicore optical ferrule 10 includes the ferrule main body 11, the plurality of insertion holes 12, two guide holes 13, an introduction hole 14 (reception portion) (refer to FIG. 2), and an injection hole 15.

The ferrule main body 11 includes the connection end surface 11a, which is a front end surface, and a rear end surface 11b. The connection end surface 11a is a surface that comes into contact with a connection target, such as another connector, when the optical connector 1 is connected to the connection target. A plurality of openings 11al are formed in the connection end surface 11a. The plurality of insertion holes 12 individually extend from the plurality of openings 11al toward an inside of the ferrule main body 11. The introduction hole 14 is located rearward of the insertion hole 12. The introduction hole 14 communicates with the insertion holes 12 and extends in the axial direction from rear ends of the insertion holes 12. The introduction hole 14 is open to the rear end surface 11b. The optical fiber 20 is introduced into the insertion hole 12 through the introduction hole 14.

The two guide holes 13 are formed in the ferrule main body 11. The two guide holes 13 are open to the connection end surface 11a. The guide pins 30 are individually inserted into the two guide holes 13. The injection hole 15 is formed on an upper surface of the ferrule main body 11. The injection hole 15 communicates with an internal space of the ferrule main body 11.

As a material of the ferrule main body 11, polyether ether ketone (PEEK), a liquid crystal polymer (LCP), polyetherimide (PEI), polyphenylene sulfide (PPS), or a mixture thereof may be adopted. A filler such as a glass fiber may be added to the above material. A resin other than the above may be adopted as the material of the ferrule main body 11.

As shown in FIG. 2, the optical fiber 20 includes a bare fiber 21 and a coating 22. The bare fiber 21 includes a core 21a and a cladding 21b. The cladding 21b covers the core 21a. The bare fiber 21 is formed of, for example, silica glass. The bare fiber 21 may be formed of a resin. The cladding 21b has a lower refractive index than that of the core 21a. Therefore, light can be confined in the core 21a. The coating 22 partially covers the bare fiber 21 and has a function of protecting the bare fiber 21. The coating 22 is formed of a resin or the like. For example, the material of the coating 22 may be a UV-curable resin. In a front end portion of the optical fiber 20, the coating 22 is not provided and the bare fiber 21 is exposed. The bare fiber 21 is inserted into the insertion hole 12 of the multicore optical ferrule 10. The introduction hole 14 of the multicore optical ferrule 10 can receive the coating 22 of the optical fiber 20.

The insertion hole 12 includes a small-diameter portion 12a (first inner diameter portion) and a large-diameter portion 12b (second inner diameter portion). The small-diameter portion 12a is open to the connection end surface 11a. The large-diameter portion 12b is located rearward of the small-diameter portion 12a. An inner diameter of the large-diameter portion 12b is larger than an inner diameter of the small-diameter portion 12a. The large-diameter portion 12b has a function as a guide for allowing the bare fiber 21 to easily enter the small-diameter portion 12a. The small-diameter portion 12a has a function of determining the position of the bare fiber 21. The position of each bare fiber 21 is determined inside the small-diameter portion 12a, so that optical connection between the optical connector 1 and the connection target is achieved.

The boot 40 is a tubular member through which the plurality of optical fibers 20 are inserted. The boot 40 is fixed to a rear end portion of the multicore optical ferrule 10. The boot 40 has a function of protecting the optical fiber 20.

The adhesive 50 has a function of fixing the plurality of optical fibers 20 to the multicore optical ferrule 10. As a material of the adhesive 50, for example, a thermosetting resin may be used. More specifically, the material of the adhesive 50 may be an epoxy resin. The adhesive 50 is injected into the internal space of the ferrule main body 11 through the injection hole 15. The injected adhesive 50 enters an inside of the introduction hole 14 and an inside of the insertion hole 12. That is, the adhesive 50 is disposed between the optical fiber 20 and the introduction hole 14, between the bare fiber 21 of the optical fiber 20 and the large-diameter portion 12b of the insertion hole 12, and between the bare fiber 21 of the optical fiber 20 and the small-diameter portion 12a of the insertion hole 12.

As shown in FIG. 3, a plurality of micro holes are formed on an inner wall of the insertion hole 12. The micro holes are recessed portions recessed from the inner wall of the insertion hole 12. The width of an opening of the micro hole is 1.0 μm or greater. The width of the opening of the micro hole may be, for example, 1.0 μm or greater and 9.0 μm or less. In one or more embodiments, the plurality of micro holes are formed in both an inner wall of the small-diameter portion 12a and an inner wall of the large-diameter portion 12b. The plurality of the micro holes are formed at least in a portion of the small-diameter portion 12a at a predetermined distance in the axial direction from an end of the small-diameter portion 12a on the side of the connection end surface 11a.

Here, in order to reduce a splice loss in the connection between the optical connector 1 and the connection target, it is required to stabilize the position of the bare fiber 21 exposed on the connection end surface 11a. Therefore, it is desired that the bare fiber 21 of the optical fiber 20 firmly adheres to the multicore optical ferrule 10 in the vicinity of the connection end surface 11a.

In one or more embodiments, because the plurality of micro holes are formed in the inner wall of the insertion hole 12, an adhesion area between the insertion hole 12 and the adhesive 50 can be increased. In addition, because the adhesive 50 enters the plurality of micro holes, adhesive strength between the insertion hole 12 and the adhesive 50 is increased by the anchor effect. Therefore, the bare fiber 21 of the optical fiber 20 can firmly adhere to the multicore optical ferrule 10 (insertion hole 12) by the adhesive 50. In particular, because the plurality of micro holes are formed on the inner wall of the small-diameter portion 12a that is open to the connection end surface 11a, the bare fiber 21 can firmly adhere to the multicore optical ferrule 10 in the vicinity of the connection end surface 11a.

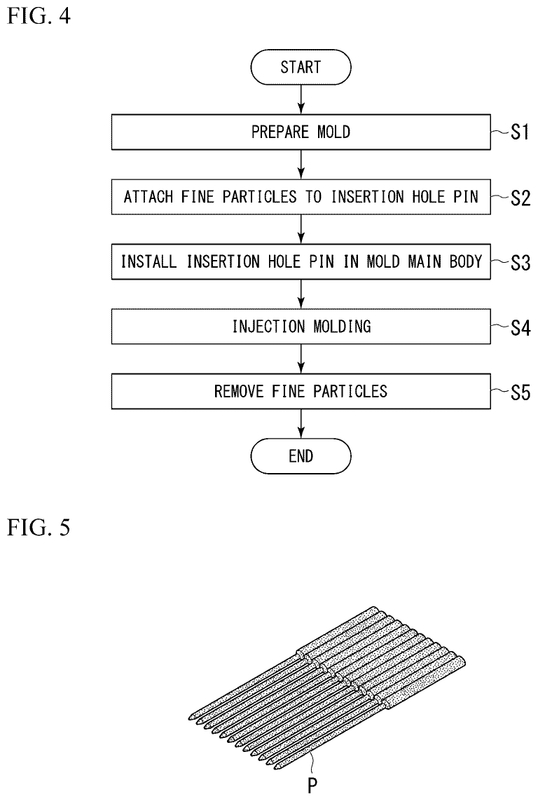

Hereinafter, an example of a manufacturing method of the multicore optical ferrule 10 will be described. In one or more embodiments, the multicore optical ferrule 10 is formed by injection molding. FIG. 4 is a flowchart showing an example of the manufacturing method of the multicore optical ferrule 10 according to one or more embodiments.

First, a mold for injection molding is prepared (step S1). The mold includes a mold main body configured to form an outer surface of the ferrule main body 11, and molding pins configured to form holes of the multicore optical ferrule 10. The molding pins include an insertion hole pin P configured to form the insertion hole 12.

Next, as shown in FIG. 5, a volatile solvent containing fine particles is sprayed onto the insertion hole pin P to attach the fine particles to the insertion hole pin P (step S2). The material of the fine particles is, for example, carbon such as graphite or ceramics such as boron nitride. The particle size of the fine particles may be, for example, 1.0 μm or greater and 9.0 μm or less. The median diameter of the fine particles may be, for example, 3.0 μm or greater and 3.5 μm or less. As a specific example, in a case where graphite fine particles having an average diameter of 3.0 μm were used, favorable results were obtained. Although the surface roughness (arithmetic average roughness Ra) of the insertion hole pin P was 0.02 μm or greater and 0.03 μm or less, by attaching graphite fine particles to the insertion hole pin P, micro holes corresponding to a shape of the fine particles were formed in the inner wall of the insertion hole 12. In addition, in a case where boron nitride fine particles having an average diameter of 8.5 μm were used, favorable results were obtained.

Next, the molding pins including the insertion hole pins P to which the fine particles have been attached are installed in a cavity of the mold main body (step S3).

Thereafter, the injection molding is performed (step S4). Specifically, a high-temperature molten resin is injected into the cavity of the mold main body, and the resin is cooled and solidified. The solidified resin is taken out from the mold. Because the fine particles are attached to the insertion hole pin P, the insertion hole pin P can be easily pulled out from the solidified resin.

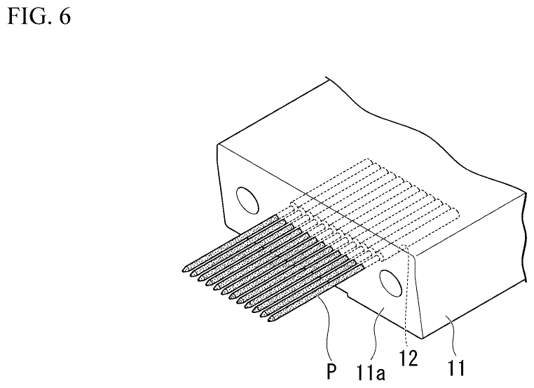

As shown in FIG. 6, the insertion hole pins P form the insertion holes 12 in the ferrule main body 11. In addition, the shape of the fine particles attached to the insertion hole pin P is transferred to the inner wall of the insertion hole 12, so that the plurality of micro holes are formed in the inner wall of the insertion hole 12. Dimensions of the micro holes can be adjusted by adjusting the particle size of the fine particles to be attached to the insertion hole pin P. Formation positions of the micro holes in the insertion hole 12 can be adjusted by adjusting attachment positions of the fine particles to the insertion hole pin P.

After that, the fine particles remaining on the inner wall of the insertion hole 12 are removed by washing (step S5). As a result, the multicore optical ferrule 10 is manufactured.

As described above, the multicore optical ferrule 10 according to one or more embodiments includes the ferrule main body 11 including the connection end surface 11a to be connected to a connection target, and the plurality of insertion holes 12 which extend from the connection end surface 11a toward the inside of the ferrule main body 11 and through which the optical fiber 20 is insertable, in which each of the plurality of insertion holes 12 includes the small-diameter portion 12a that is open to the connection end surface 11a and the large-diameter portion 12b that has the larger diameter than the diameter of the small-diameter portion 12a, and the inner wall of the small-diameter portion 12a includes the plurality of micro holes.

In addition, the optical connector 1 according to one or more embodiments includes the multicore optical ferrule 10, the plurality of optical fibers 20 inserted into the plurality of insertion holes 12, and the adhesive 50 configured to cause the plurality of optical fibers 20 to adhere to the multicore optical ferrule 10, in which the adhesive 50 is disposed at least between the bare fiber 21 of the optical fiber 20 and the small-diameter portion 12a.

With such a configuration, because the plurality of micro holes are formed on the inner wall of the small-diameter portion 12a that is open to the connection end surface 11a, it is possible to improve adhesive strength of the bare fiber 21 of the optical fiber 20 with respect to the multicore optical ferrule 10 in the vicinity of the connection end surface 11a.

In addition, the multicore optical ferrule 10 includes the introduction hole 14 that communicates with the large-diameter portion 12b and is configured to receive the coating 22 of the optical fiber 20.

In addition, the large-diameter portion 12b includes the plurality of micro holes. Accordingly, it is possible to cause the bare fiber 21 of the optical fiber 20 to more firmly adhere to the multicore optical ferrule 10.

In addition, widths of openings of at least some micro holes among the plurality of micro holes are 1 μm or greater. Accordingly, it is possible to cause the bare fiber 21 of the optical fiber 20 to more firmly adhere to the multicore optical ferrule 10.

In addition, the manufacturing method of the multicore optical ferrule 10 according to one or more embodiments includes preparing the mold main body configured to form the outer surface of the ferrule main body 11 and the insertion hole pin P configured to form the insertion hole 12, attaching fine particles to the insertion hole pin P, installing the insertion hole pin P to which the fine particles have been attached in the mold main body, injecting a resin into the mold main body and solidifying the resin, and removing the fine particles remaining in the solidified resin.

It should be noted that the technical scope of the present invention is not limited to the above-described embodiments, and various modifications can be made without departing from the scape of the present invention.

For example, in the manufacturing method of the multicore optical ferrule 10 in the above-described embodiments, in order to easily take out the resin solidified in step S4 from the mold, a mold release agent may be applied to the mold before step S4. In addition, in order to remove internal stress of the multicore optical ferrule 10, a heat treatment may be performed on the multicore optical ferrule 10 after step S5.

In addition, for example, the optical connector may be applied to a co-packaged optics (CPO) structure in which the optical fiber is directly connected to an optical integrated circuit mounted on an electronic substrate by bringing the optical fiber into contact with the optical integrated circuit. In this case, there is a possibility in which, as the optical connector is heated together with electronic components of the optical integrated circuit when reflowing the electronic components, a part of the adhesive configured to cause the optical fiber to adhere to the ferrule is peeled off, which may cause the optical fiber to retract (piston) in the axial direction.

As described above, in one or more embodiments, because the plurality of micro holes are formed on the inner wall of the insertion hole 12, the adhesion area between the insertion hole 12 and the adhesive 50 can be increased. In addition, the adhesive strength between the insertion hole 12 and the adhesive 50 is increased by the anchor effect. Therefore, even in a case where the optical connector 1 is applied to the CPO structure, it is possible to reduce the peeling of the adhesive 50 by the reflow of the electronic components of the optical integrated circuit, and it is possible to reduce the occurrence of the retraction (pistoning) of the optical fiber 20 in the axial direction.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A multicore optical ferrule comprising:
a main body including a connection end surface configured to connect to a connection target; and
insertion holes into which optical fibers are respectively inserted, wherein
each of the insertion holes extends from the connection end surface toward an inside of the main body,
each of the insertion holes has:
a first inner diameter portion open to the connection end surface; and
a second inner diameter portion having a diameter larger than a diameter of the first inner diameter portion, and
an inner wall of the first inner diameter portion of each of the insertion holes includes micro holes.

2. The multicore optical ferrule according to claim 1, further comprising:
a reception portion, connected to the second inner diameter portion of each of the insertion holes, that receives a coating of each of the optical fibers.

3. The multicore optical ferrule according to claim 2, wherein the second inner diameter portion of each of the insertion holes includes the micro holes.

4. The multicore optical ferrule according to claim 1, wherein one or more of the micro holes each have a width of an opening greater than or equal to 1 μm.

5. An optical connector comprising:
the multicore optical ferrule according to claim 1;
the optical fibers; and
an adhesive, disposed between a bare fiber of each of the optical fibers and the first inner diameter portion of each of the insertion holes, that causes the optical fibers to adhere to the multicore optical ferrule.

6. A manufacturing method of a multicore optical ferrule that includes a main body including a connection end surface and an insertion hole extending from the connection end surface toward an inside of the main body, the manufacturing method comprising:
attaching fine particles to an insertion hole pin configured to form the insertion hole;
installing the insertion hole pin, to which the fine particles have been attached, in a mold main body configured to form an outer surface of the main body;
injecting a resin into the mold main body and solidifying the resin; and
removing the fine particles from the solidified resin.
